(19) United States
(12) Patent Application Publication
(10) Pub. No.: US 2011/0248435 A1
(43) Pub. Date: Oct. 13, 2011

(54) MAGNETIC CLAMPING DEVICE FOR HOLDING A WORKPIECE IN A PRECISELY FIXTURED POSITION

(76) Inventors: Giovanni Cosmai, Rescaldina (IT); Roberto Faranda, Milano (IT); Antonino Giglio, Via Oratorio 42 (IT); Michele Cardone, Trezzano (IT); Giorgio Magalini, Verona (IT)

(21) Appl. No.: 13/140,220

(22) PCT Filed: Dec. 16, 2008
(86) PCT No.: PCT/IT2008/000764

§ 371 Date: Jun. 16, 2011

(51) Int. Cl. B23Q 3/154

(52) U.S. Cl. 269/8

(57) ABSTRACT

The present invention concerns a clamping device (8) for magnetically holding a workpiece (7) in a precisely fixtured position, which comprises a base (10) having a first side (11) and a second side (12) at the larger opposed surfaces, a workpiece support plate (13) having a first side (14) and a second side (15) at the larger opposed surfaces, a first magnetic circuit (17) contained in said base (10) for creating a magnetic field, the first side (14) of said workpiece support plate (13) being attracted by the second side (12) of said base (10) by means of said magnetic field when said first magnetic circuit (17) is in an activated state, centering and locating means (20) for centering said workpiece support plate (13) in an angular position relative to said base (10). The clamping device (8) is characterized in that said at least one first magnetic circuit (17) comprises at least one pole piece (18) which is adapted to generate at least one magnetic flux for turning both said second side (12) and said first side (11) of said base (10) into a magnetically activated state, so that said first side (11) of said base (10) can be magnetically secured to a support (16) and that said second side (12) of said base (10) can be magnetically secured to said first side (14) of said workpiece support plate (13) thereby providing a one-piece configuration of said support (16) of said base (10) with said workpiece support plate (13).

The present invention relates to a magnetic clamping device for holding a workpiece in a precisely fixtured position, according to the preamble of claim 1.

Accurate machining of ferrous workpieces requires great skill and expertise, as well as the use of machine tools, such as 3- or 5-axis milling machines, whose features rely on correct location and precise definition of a so-called reference point.

Such reference point is used to determine the point of origin of the axes of the machine tools, relative to which all the dimensions of the product to be machined from the workpiece are measured, processed and deduced.

In prior art, mechanical clamping devices of hydraulic or pneumatic type are known which, when associated with machine tools, allow reference point, i.e. zero point, identification.

These devices should be able to identify and maintain the zero point not only at the time of workpiece positioning but especially during the workpiece machining process.

Nonetheless, this is not always ensured, because the vibrations induced in the workpiece by machining are also transferred to the clamping device and do not allow precise and repeatable processes to be carried out with identical results with time.

In an attempt to limit such vibrations, either the extent or the precision of workpiece machining is reduced, for later correction by a finishing step, both approaches involving high manufacturing costs.

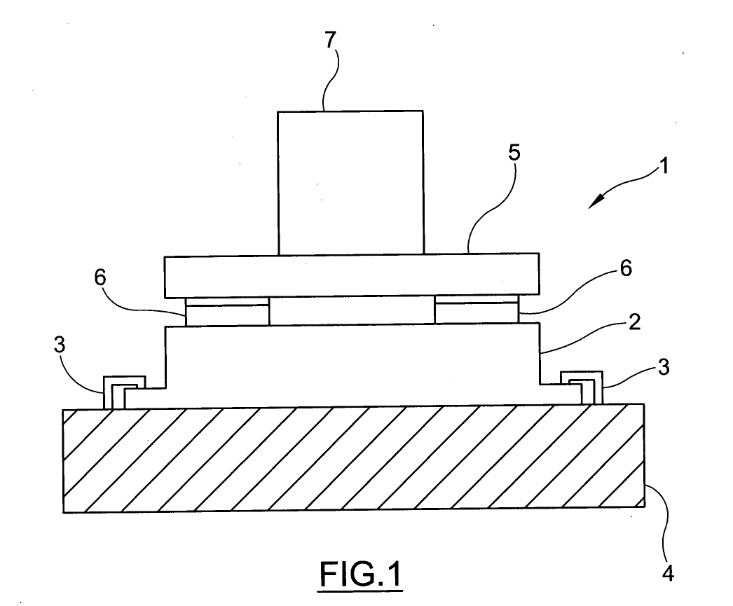

Thus, also referring to FIG. 1, a common mechanical clamping device 1 is shown, which comprises a base 2, mechanically secured to a bed 4 of a machine tool (not shown) by means of a fastening kit 3, e.g. including brackets.

A workpiece support plate 5 is associated with said base 2 by means of a plurality of supports 6.

The workpiece support plate 5 supports a workpiece 7 in a precisely fixtured position relative to the workpiece support plate by appropriate mechanical fastener means (not shown in FIG. 1).

It can be further noted that the workpiece support plate 5 has an area approximately equal to the area of the base 2 and that, when it is placed onto the base 2, it is only supported by the supports 6 over a limited portion of its surface. The portion that is supported by the supports 6 is usually arranged to be less than 5% of the workpiece support plate area.

Therefore, the vibrations induced in the workpiece 7 by machining are transferred to the base 2 through the workpiece support plate 5 and the supports 6. The base 2 in turn transfers the vibrations to the bed 4 of the machine table, thereby affecting proper location of the zero point.

As a result, the workpiece 7 is not machined with the highest accuracy that should be theoretically required.

In an attempt to limit the vibrations induced in the workpiece 7 by machining, clamping device manufacturers have made the workpiece support plate 5 and the supports 6 from a material that can at least partly absorb vibrations, thereby also limiting the weight over the machine tool bed 4.

For example, the workpiece support plate 5 and the supports 6 have been made from light alloys or aluminum instead of steel.

Nonetheless, while this has afforded partial absorption of the vibrations generated during machining of the workpiece 7, it also has given rise to additional problems, such as:
early wear of the workpiece support plate 5 due to the lower hardness of light alloys or aluminum as compared with steel;
a greater height of the light alloy or aluminum workpiece support plate 5 as compared with a steel workpiece support plate, with a reduced span available to the machine tool for workpiece machining;
different thermal expansion coefficients for the base 2, the workpiece support plate 5 and the supports 6, resulting in different behaviors as temperatures change;
point-like concentration of the machining forces induced in the workpiece 7, due to the small contact surface provided by the supports 6 between the workpiece support plate 5 and the base 2, and generation of undesired deflections in the workpiece support plate 5.

Magnetic clamping devices are also known in the art, which have partially obviated the above drawbacks.

For example, U.S. Pat. No. 4,777,463 discloses a clamping device which comprises a magnetic base made of steel and a workpiece support plate made of aluminum, whose equipment is permanently attached to the plate in a precisely established position on the plate. The plate is removably located by mechanical connections and using centering members in a precise position on the base whereas a magnetic force is later used for clamping and locking the tool plate in a predetermined position.

The base is secured to the base of a machine tool by appropriate mechanical connections, such as bolts.

While the above device provides a number of advantages, it still suffers from a number of limitations, including the following:
vibrations are induced in the workpiece, and are discharged through the base connection members to the machine tool bed, thereby affecting machining accuracy;
the base has a cavity for receiving the magnetic circuit; the cavity and the magnetic circuit are enclosed by a resin layer which is exposed to wear, cracking and/or fractures due to workpiece machining and thermal expansion. When this occurs, the refrigerant fluids used in machine tools may infiltrate the cavities and cause short circuits with obvious and imaginable consequences.

Therefore, the need is strongly felt for homogeneous and total coupling of the base and the plate along their respective surfaces, to withstand vibrations and allow homogeneous distribution of forces between the bed and the base and the base and the workpiece support plate.

The need is also felt for magnetic clamping devices having a lower profile, for easier machining of bulky workpieces, and a lighter weight, to reduce the load on the machine tool base or, under the same weight conditions, to obtain larger clamp surfaces.

These problems are solved by a clamping device as defined in claim 1.

The present invention provides a clamping device in which contact is ensured between the entire extension of the base and the machine tool bed and between the base and the plate, thereby providing a bed-to-base and a base-to-workpiece support plate connection comparable to a one-piece condition.

This affords a reduction of vibrations transferred during workpiece machining and prevents deflections from building up in the workpiece support plate, while always ensuring zero-point location both when workpiece is placed on the workpiece support plate and during workpiece machining.

Furthermore, the considerable reduction of vibrations afforded by the device of the invention allows quicker machining, greater material removal and shorter manufacturing times, as well as a more effective exploitation of the machine tool with consequent economic advantages.

Furthermore, the present invention provides a compact clamping device, due to the low profile of the base; this affords a smaller bulk and a lighter weight and extends the application range for the machine tool.

Furthermore, the magnetic circuit of the clamping device ensures a high clamping force, arranged over the entire area of the base and/or the workpiece support plate and is not limited to the points with the fastening kit, thereby affording greater reliability, less maintenance and a longer life.

Furthermore, with the present invention permanent connections are no longer required. This is because the magnetic circuit requires no constant power supply but only energizing and de-energizing pulses.

Finally, if the clamping device of the present invention is used with automated systems, the electric connection may be directly provided by the automated systems, and requires no specially designed and dedicated systems.

The characteristics and advantages of the invention will appear from the following detailed description of one practical embodiment, which is illustrated without limitation in the annexed drawings, in which:

FIG. 1 shows a mechanical clamping device according to the prior art;

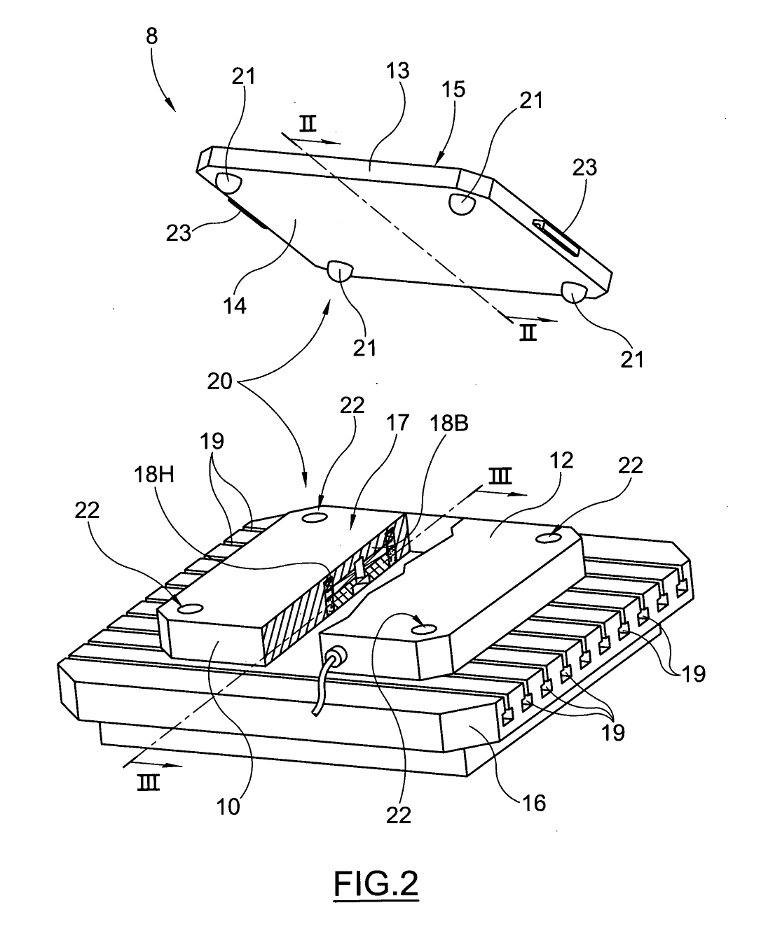

FIG. 2 is a perspective exploded view of the elements that form the clamping device, such as the base and the workpiece support plate, when the base is associated with a support, according to the present invention;

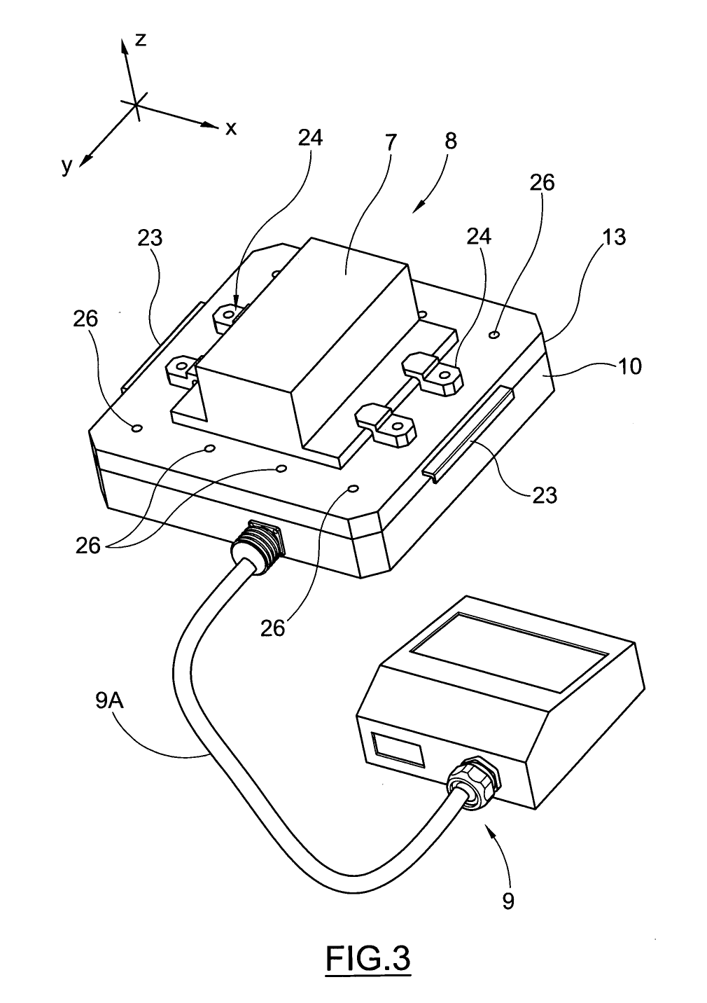

FIG. 3 is a perspective view of the clamping device when it is used and connected to a control unit, according to the present invention;

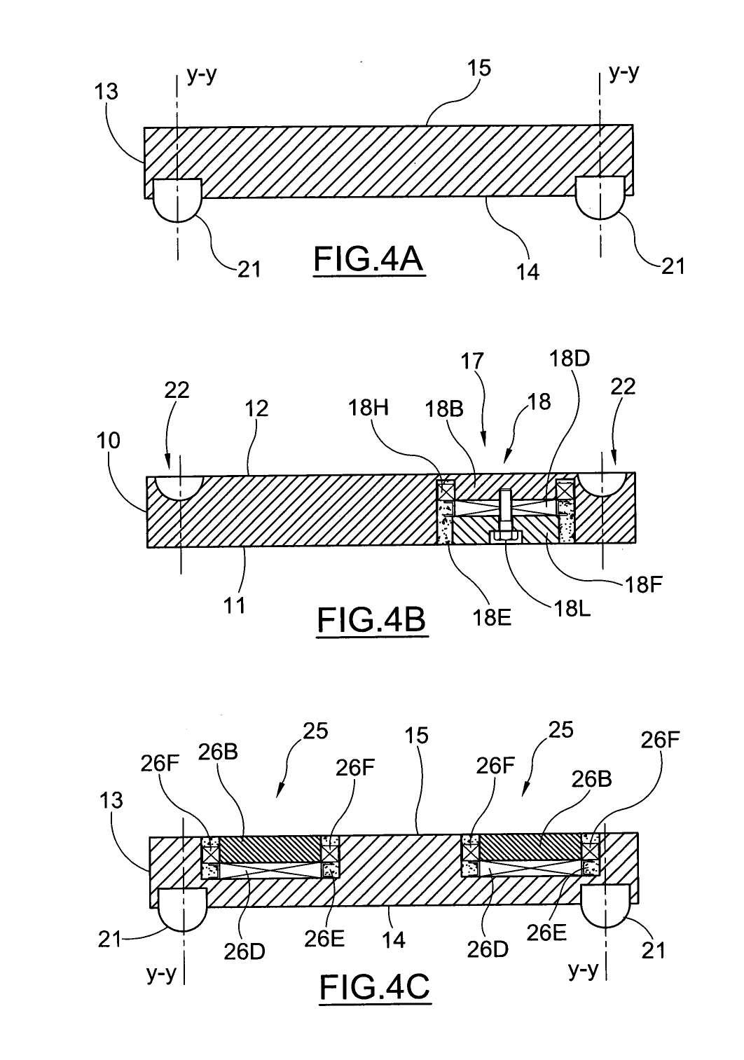

FIG. 4A is a sectional view taken along line II-II of the base as shown in FIG. 2;

FIG. 4B is a sectional view taken along line III-III of the workpiece support plate of the clamping device as shown in FIG. 2;

FIG. 4C is a sectional view of another embodiment of the workpiece support plate of the present invention;

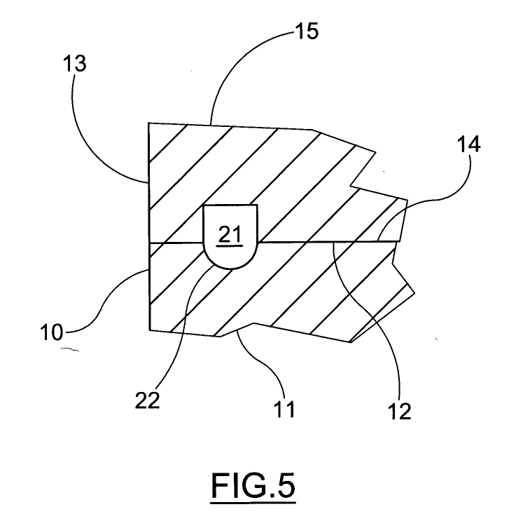

FIG. 5 is a sectional view of a centering element used in the clamping device as shown in FIG. 2, when the workpiece support plate is in contact with the base.

Referring to the attached FIGS. 2 to 5, numeral 8 generally designates a magnetic clamping device for holding a workpiece 7 in a fixtured position, to define a zero point.

The clamping device 8 may be operably connected to a control and monitoring unit 9 which is adapted to monitor and control the operating states of the magnetic circuits 17, 25, 26 in the clamping device 8.

Particularly, the control unit 9 includes electric/electronic means which are operably connected by an electric connection 9A with the electric elements that are part of the magnetic circuits in the clamping device 8.

The clamping device 8 comprises:
a base 10 having a first side 11 and a second side 12 at the larger opposed surfaces and
a workpiece support plate 13, also having a first side 14 and a second side 15 at the larger opposed surfaces.

For simplicity and without prejudice to the general scope of the invention, it will be assumed herein that:
the first side 11 of the base 10 is the bottom side, whereas the first side 14 of the workpiece support plate 13 is the side that is magnetically attracted by the second side 12 of the base 10 and the second side 15 of the workpiece support plate 13 is the side with which the workpiece 7 is designed to be associated;
the larger surfaces of the base 10 and the workpiece support plate 13 have the same size.

Furthermore, the base 10 and the workpiece support plate 13 are assumed herein to define a parallelepiped with a square cross section.

The above being assumed, also referring to FIG. 2, there appears that the side 11 of the base 10 may be laid in a precisely established position onto a support 16, such as a machine tool bed made of a ferromagnetic material (the machine tool not being shown herein).

For example, locating members (not shown) are used, which are designed to be removably associated with the bed 16 to define the reference point of the machine tool relative to the base 10 of the device 8.

Concerning the workpiece support plate 13, it is characterized in that it is adapted to be quickly and firmly located in an established position on the side 12 of the base 10, but is also adapted to be quickly removed from the base upon completion of the machining process on the workpiece 7.

Gripping members 23 are provided for easy grasp by operators, to facilitate handling of the workpiece support plate 13.

Otherwise, the workpiece support plate 13 is adapted to be automatically handled by special mechanical arms.

The workpiece 7 may be attached to the side 15 of the workpiece support plate 13 by a fastening kit, comprising for instance screws, brackets and expansion bolts (see FIG. 3).

For this purpose, the second side 15 of the workpiece support plate 13 comprises, for instance, a plurality of holes 26 adapted to engage with the elements of the fastening kit 15.

Particularly, the holes 26 are calibrated holes, each hole being designed to define a center axis, wherefore the center-to-center distance iₘ between the axes of two contiguous holes may be measured with a precision complying with the following relation:

iₘ=iᵢ±10⁻⁵ m

where iₘ is the actually measured center-to-center distance and iᵢ is the ideal center-to-center distance between two contiguous holes of said first plurality of holes.

In other words, the holes 26 on the side 15 of the workpiece support plate 13 are arranged and formed with precision to the nearest hundredth of a millimeter.

Furthermore, these holes 26 may be arranged in a matrix pattern, i.e. along the axes X-Y of a reference Cartesian system.

Thus, the precise position of the workpiece 7 may be located and established relative to the workpiece support plate 13, according to the hole selected for workpiece positioning.

Referring now to FIGS. 4A and 4B, a magnetic circuit 17 is disposed in the base 10, for creating a magnetic circuit to be activated by the control unit 9.

The magnetic circuit 17 as shown in the figures is advantageously a self-clamping electro-permanent circuit, i.e. a magnetic circuit capable of magnetically activating both the surface of the second side 12, and the surface of the first side 11 of the base 10.

Particularly, the magnetic circuit 17 allows the base 10 to:
be magnetically held against the machine tool bed 16 without using a mechanical fastening kit as well as
magnetically secure the side 15 of the workpiece support plate 13 to the side 12 of the base 10, when the workpiece support plate 13 is in the operating state as shown in FIG. 3.

The magnetic circuit 17 includes at least one pole piece 18, preferably an even number of pole pieces, e.g. four, six or eight.

Advantageously, the pole pieces 18 complete the extension of the surface of the side 12 to turn it to a magnetically active state.

It shall be noted that one pole piece only is shown in the annexed figures for simplicity.

Particularly, each pole piece 18 comprises:
a first pole piece collector 18B, one lateral portion thereof defining a portion of the second side 12 of the base 10, wherein the first pole piece collector 18B is formed of one piece with the structure of the base 10,
a first magnetic core 18D, e.g. AlNiCo,
an electric coil 18E around the first magnetic core 18D, for changing its magnetization state,
a second pole piece collector 18F, one lateral portion thereof defining a portion of the first side 11 of the base 10, which is fastened, for example, in the particular embodiment as shown herein, to the first collector 18B and the first magnetic core 18D by a screw 18L.

The pole piece 18 further comprises second magnetic cores 18H, e.g. made of ferrite or NdFeB, which are suitably oriented and placed proximate to the faces of the first pole piece collector 18B.

It shall be noted that, if the magnetic circuit 17 is made of a single pole piece 18, the magnetic flux that comes out of such single pole piece 18 through the first side 11 of the base 10 mainly recloses into the frame of the base 12.

Conversely, if the magnetic circuit 17 is made of two or more pole pieces 18, then the magnetic flux that comes out of each pole piece recloses at least into the adjacent pole piece of opposite polarity.

Therefore, in an operating state set through the control and monitoring unit 9, the magnetic circuit 17 is adapted to generate a magnetic flux capable of:
coming out of the first side 11 of the base 10,
magnetically activating also the second side 12 of the base 10 and
generating another magnetic flux on said second side 12 of the base 10, by the presence of second magnetic cores 18H, for magnetically securing the first side 14 of the workpiece support plate 13 even when the first magnetic cores 18D are in a deactivated state.

This ensures coupling of the base 10 to the bed 16 all along the surface of the first side 11 for more effective vibration damping.

For a more detailed description of the operation and technical features of the magnetic circuit 17, reference may be made to patent application PCT/IT2008/000278 and PCT/IT2008/000279 by the applicants hereof, incorporated herein by reference.

As shown in FIG. 4B, the first pole piece collector 18B of the pole piece 18 is formed of one piece with the frame of the base 10, by removing a sufficient amount of base material from the side 11 of the base, to define the pole piece collector 18B.

Such process allows the frame of the base 10 to be formed of one piece with the first collector 18B of the pole piece 18.

This advantageously provides a low-profile, light-weight base 10, as compared with currently available clamping devices, otherwise this one-piece construction provides a base 10 having a larger clamping area than in currently available clamping devices.

It will be also appreciated that this one-piece construction can limit both vibrations and/or deflections induced during machining of the workpiece 7 and any deformation caused by thermal expansion.

It will be appreciated that, the provision of a one-piece construction of the collector 18B with the base 10, the side 12 of the base 10 is also free of holes and resin.

Thus, the clamping surface defined by the second side 12 is formed of one material, such as the material that forms the base 10.

Also, such clamping surface defined by the second side 12 of the base 10 has a flat and even surface.

In other words, the second side 12 of the base 10 is a flat, ferromagnetic clamping surface.

Preferably, the base 10 and the workpiece support plate 13 are made from the same metal material, such as steel or any other ferromagnetic material.

Advantageously, under these conditions, the base 10 and the workpiece support plate 13 are joined into a construction resembling a one-piece construction, with the side 12 and the side 14 of the base 10 and the workpiece support plate 13 respectively are in mutual contact along their surfaces.

For a more detailed description of the process for obtaining the magnetic base with a flat ferromagnetic clamping surface, reference may be made to patent application PCT/IT2008/000278 and PCT/IT2008/000279 by the applicants hereof, incorporated herein by reference.

Otherwise, a fastening kit may be also used, comprising screws, brackets and/or expansion bolts for adding a mechanical fastening effect to magnetic clamping of the side 11 of the base 10 to the machine tool bed 16.

For this purpose, the bed 16 has, for instance, rows of longitudinally upwardly open slits 19 having an inverted T cross section.

The base 10 further has locating and centering members 20 that can center the workpiece support plate 13 relative to the base 10.

Particularly, the centering members 20 are used to angularly secure the workpiece support plate 13 to the base 10 and are made, for example, from the same material as the base 10, such as steel.

Referring for instance to FIGS. 4A-4C and 5, the centering members include:
positioning means 21 overhanging in a predetermined direction Y-Y from the side 14 of the workpiece support plate 13 and
counter-positioning means 22 proximate the side 12 of the base 10 and at least partially complementary to the means 21.

The means 21 and counter-means 22 mate in an at least partial form fit relationship, when the workpiece support plate 13 is secured to the base 10. Preferably, the means 21 and counter-means 22 are at the vertices of the workpiece support plate 13 and the base 10 respectively.

The means 21 and counter-means 22 are provided in an even number, at least two, preferably four.

For instance, the means 21 and counter-means 22 may be as shown and described in U.S. Pat. No. 3,723,928.

In the particular embodiment of the annexed figures, the positioning means 21 are hemispherical pins and the counter-positioning means 22 are hemispherical recesses.

Therefore, the clamping device 8 allows location and maintenance of the zero point because:
the calibrated holes 26 define the precise position of the workpiece 7 relative to the side 15 of the workpiece support plate 13;
the workpiece support plate 13 is in turn placed in a precisely fixtured position relative to the base 10, by the positioning and centering means 20 and
the base 10 is also placed in a precisely fixtured position relative to the machine tool bed 16.

Referring now to FIG. 4C, in one alternative embodiment of the workpiece support plate 13, such workpiece support plate 13 may also include an additional magnetic circuit 25 for securing the workpiece 7 to the second side 15 of the plate.

It shall be noted that the magnetic circuit 25 may be controlled either through the control unit 9 or through another control unit (not shown) expressly dedicated to the control of said magnetic circuit 25.

The magnetic circuit 25 may be an electro-permanent circuit capable of turning the side 15 of the workpiece support plate 13 into a magnetically active state for magnetically securing the workpiece 7.

The magnetic circuit 25 comprises a plurality of pole pieces 26, although two pole pieces only are shown in FIG. 4C, each having:
a pole piece collector 26B, one lateral portion whereof defines a portion of the second side 15 of the base 10,
a first magnetic core 26D, e.g. AlNiCo,
an electric coil 26E around the first magnetic core 26D, for changing its magnetization state,
a second magnetic core 26F, e.g. made of ferrite or NdFeB which is suitably oriented and placed proximate to the faces of the pole piece collector 26B.

A magnetic clamping device will be thus obtained, which is capable of magnetically holding the workpiece 7. This provides great advantages, in that the workpiece support plate 13 is a magnetic clamping surface, wherefore the workpiece 7 may have five free faces and be uniformly secured thereto.

The workpiece 7 may be also firmly secured to the side 15 of the workpiece support plate 13 using both the above mentioned fastening means 24 and the magnetic field generated by the magnetic circuit 25.

This will also ensure repeatable and consistent positioning of the workpiece 7 relative to the workpiece support plate 13.

With the above clamping device 8, when the workpiece support plate 13 is to be associated with the base, then:
the side 11 of the base 10 will be magnetically secured to the machine tool bed 16, by means of the circuit 17,
the control unit 9 will be operably connected to the base 10 and
the workpiece support plate 13 will be placed in a loading area, where the workpiece 7 may be mechanically attached to the side 15 by the fastening kit 24 and/or magnetically clamped thereto by means of the magnetic circuit 25.

Then, the workpiece support plate 13 with the workpiece 7 attached to the side 15 is placed in the proximity of the base 10, while taking care of the position of the positioning and centering means 21 relative to the counter-means 20.

Particularly, the positioning and centering means 21 shall mate with respective counter-means 20 to ensure zero point definition.

When the workpiece support plate 13 is in its right position on the magnetic base 10, the side 12 of the base 10 and the side 14 of the workpiece support plate 13 are in surface contact, as exemplified by FIG. 5.

As the control unit 9 is controlled to activate the magnetic circuit 17 and magnetically activate both sides 11 and 12 (i.e. the larger sides) of the base 10, the workpiece support plate 13 is attracted to the base 10, thereby magnetically clamping the workpiece support plate 13 to the base 10.

Once machining of the workpiece 7 has been completed, the magnetic circuit 17 and/or the magnetic circuit 25 are deactivated through the control unit 9.

Then, the workpiece support plate 13 may be removed from the base 10 using the gripping means 23, and a new working cycle may be started with another workpiece 7 that might also lie on a different workpiece support plate 13.

Those skilled in the art will obviously appreciate that a number of changes and variants may be made to the clamping device as described hereinbefore, without departure from the scope of the invention, as defined in the following claims.

1. A magnetic clamping device for holding a workpiece in a precisely fixtured position, comprising:
a base having a first side and a second side at the larger opposed surfaces,
a workpiece support plate having a first side and a second side at the larger opposed surfaces,
at least one first magnetic circuit contained in said base and capable of generating a magnetic field,
the first side of said workpiece support plate being attracted by the second side of said base by means of said magnetic field when said first magnetic circuit is in an activated state,
centering means capable of centering said workpiece support plate in a precise position relative to said base,
characterized in that said at least one first magnetic circuit comprises at least one pole piece which is adapted to generate at least one magnetic flux for turning both said second side and said first side of said base into a magnetically activated state, so that said first side of said base can be magnetically secured to a support and that said second side of said base can be magnetically secured to said first side of said workpiece support plate thereby providing a one-piece clamping device when said workpiece support plate is magnetically associated with said support of said base.

2. A clamping device as claimed in claim 1, wherein said at least one magnetic flux comes out of said at least one pole piece through said first side of said base and recloses at least partially into the frame of said base.

3. A clamping device as claimed in claim 1, wherein said base, said workpiece support plate and said centering members are all made from the same ferromagnetic material.

4. A clamping device as claimed in claim 1, wherein said second side of said base has a surface entirely made of metal.

5. A clamping device as claimed in claim 1, wherein said first side of said workpiece support plate has a surface entirely made of metal.

6. A clamping device as claimed in claim 1, wherein said workpiece support plate has fixturing means for fixturing said workpiece.

7. A clamping device as claimed in claim 6, wherein said fixturing means include a second magnetic circuit contained in said workpiece support plate.

8. A clamping device as claimed in claim 6, wherein said fixturing means comprise a plurality of holes arranged proximate said second side of said workpiece support plate, each hole of said plurality of holes defining a center axis, so that the center-to-center distance iₘ between the axes of two contiguous holes is measured with such a precision as to comply with the following relation:
iₘ=iᵢ±10⁻⁵ m
where iₘ is the actually measured center-to-center distance and is the ideal center-to-center distance between two contiguous holes of said first plurality of holes.

9. A clamping device as claimed in claim 1, wherein said centering means comprise positioning means overhanging in a predetermined direction (Y-Y) from said first side of said workpiece support plate and counter-positioning means proximate said second side of said base and at least partially complementary to said positioning means in a form fit relationship when the workpiece support plate is magnetically secured to said base.

10. A clamping device as claimed in claim 9, wherein said positioning means and said counter positioning means are at the vertices of said workpiece support plate and said base respectively.

11. A clamping device as claimed in claim 9, wherein said positioning means and said counter positioning means are provided in an even number, i.e. at least two and preferably four.
